(19) United States
(12) Patent Application Publication
(10) Pub. No.: US 2003/0173749 A1
(43) Pub. Date: Sep. 18, 2003

(54) MASTER LINK FOR CHUCKS

(76) Inventor: Marco P. Soto, Houston, TX (US)

Correspondence Address: Russell J. Egan, Suite 120, 908 Town & Country Blvd., Houston, TX, 77024-2221, US

(21) Appl. No.: 10/094,881

(22) Filed: Mar. 12, 2002

(51) Int. Cl. B23B 31/16

(52) U.S. Cl. 279/154

(57) ABSTRACT

The subject invention is a master link which comprises a heavy duty roller chain with end hooks and safety pins on each end of the chain. The master link is used in combination with a rotatable chuck, having a head with at least three jaws mounted thereon for radial movement, to hold the jaws in place during remachining operations. The chain is made into a circle with the end hooks engaging rollers of the chain to define a circle of specific size so that when it is applied around the jaws of the chuck, the master link restrains the outward movement of these jaws.

### BACKGROUND OF THE INVENTION

1. The Field of the Invention

The present invention relates to a master link for holding the jaws of a lathe chuck, or the like, during the master machining thereof and in particular to a length of roller link chain with fastening means on the ends thereof so as to form a circle of fixed circumference around the jaws to fixedly hold them in place during re-machining operations.

2. The Prior Art

Every machinist struggles when re-machining soft jaws on a multiple jaw chuck. When required to chuck parts from the inside, machinist have usually looked for a piece of scrap ring material that will be close to the diameter they are trying to machine. Such a ring serves the purpose of holding all jaws stable and allows the machinist to take the entire backlash while re-machining the soft jaws. That doesn't always work because of not having the right size ring material. Another approach is to clamp the chuck jaws toward the inside by placing a piece of stock material within the jaws to hold them in place, which is opposite the normal way for chucking up parts. This is not the proper way for the simple reason of re-machining the soft jaws the opposite way that we are trying to chuck up the parts, while attempting to hold machined parts from the inside diameter.

One known approach to this problem is discussed in U.S. Pat. No. 4,696,482 to Brown, which describes a lock ring device for locking the soft jaws of a lathe chuck, or the like, for holding the jaws during the machining thereof to fit a workpiece to be held by the jaws. The device is adjustable to adjust the jaws in the locking position for the exact amount of metal removal desired.

Another approach is described in U. S. Pat. No. 4,928,981 also to Brown A lock ring device is described for locking the soft jaws of a lathe chuck, or the like, at a desired position for the machining of the work engaging surfaces of the soft jaws. The device is adjustable to position the jaws in the locking position for the exact amount of metal removal desired. The device is designed for use with the standard soft jaws in use today.

A third approach is described in U.S. Pat. No. 5,155,898 to Gutierrez. Soft jaws in a powered rotary chuck of a lathe are fixedly secured in position, during shaping of the jaws to fit a piece of work, by an annular boring fixture. The fixture is located concentric with the center of rotation of the chuck. The fixture has three sets of multiple spaced treaded openings. Each set is oriented in a like spiral relative to the center of rotation. Three bolts with threaded shanks are engaged in the three openings. The bolts have heads fitting in counterbores in the jaws. The jaws are tightened on the heads of the bolts so that the jaws can then be shaped to the pertinent dimensions of the piece of work. The fixture is then removed and the piece of work is positioned in the jaws and the machining operations performed on the piece of work as it is being rotated by the chuck. Bolts with different diameter heads can be used to help orient the bolts to the locations of the counterbore.

The present invention overcomes many of the difficulties of the known prior art, particularly the time and difficulty of the setup, by providing a master link which can be simply and rapidly placed on a chuck and adjusted to hold the jaws thereof in a secure manner.

### SUMMARY OF THE INVENTION

The subject invention is a master link formed by a heavy duty roller chain with end hooks and safety pins on each end thereof. The master link is used in combination with a rotatable chuck having a head with at least three jaws mounted thereon for radial movement. The roller chain of the master link is first sized to encircle the jaws of the chuck. Then ends of the chain are secured in overlapping fashion by engaging the hooks with respective adjacent rollers of the chain. The master link is then placed on the chuck encircling the jaws to hold them in a very secure manner during subsequent re-machining operations.

### BRIEF DESCRIPTION OF THE DRAWINGS

The present invention will now be described, by way of example, with reference to the accompanying drawings, in which:

FIG. 1 is a perspective view of the subject invention applied to a standard lathe chuck;

FIG. 2 is a side view of the subject invention applied to a standard lathe chuck;

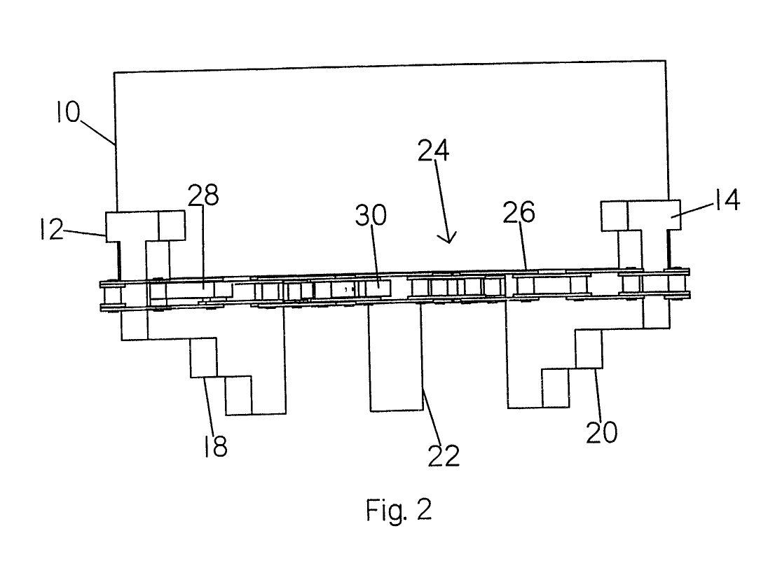

FIG. 3 is a front view of the subject invention applied to a standard lathe chuck; and

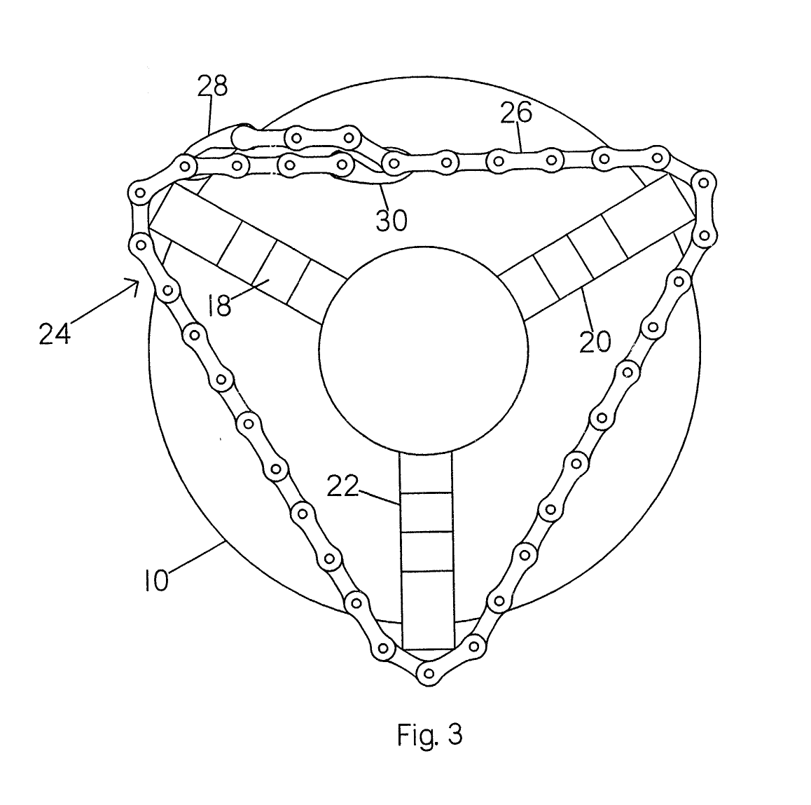

FIG. 4 is a detail of the subject invention apart from a lathe chuck.

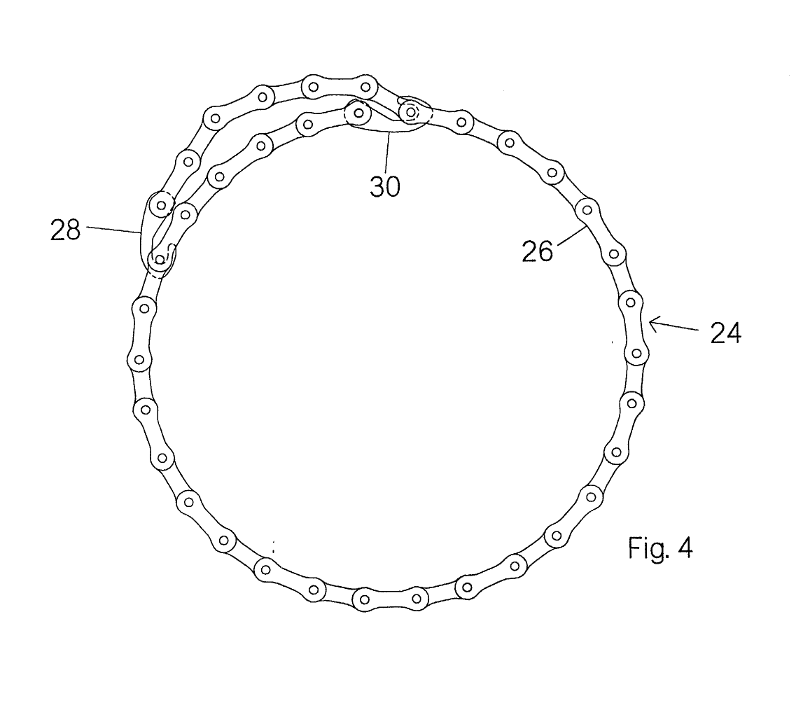

### DESCRIPTION OF THE PREFERRED EMBODIMENT

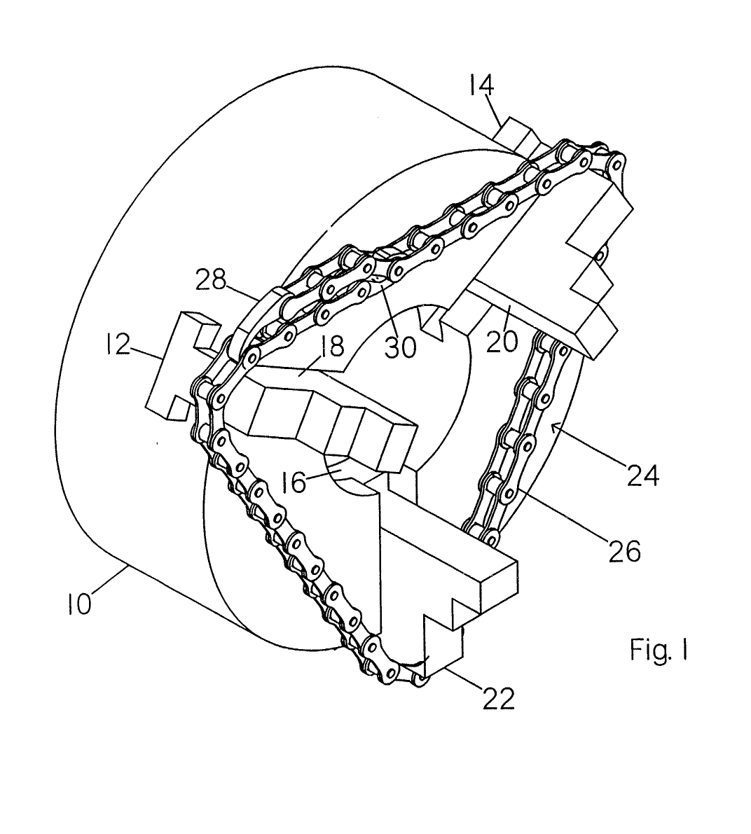

Referring to FIG. 1, there is shown a three-jaw lathe chuck having a chuck body 10 formed of a one-piece steel casting and provided with means for mounting the chuck on a spindle (not shown) of the lathe (also not shown). The chuck body 10 and the operating components thereof for effecting simultaneous gripping action by the three chuck jaws 12, 14, 16 (i.e., the jaw setting means) are of an entirely conventional construction well understood by those skilled in the art and therefor need no detailed description.

The three soft jaws 18, 20, 22 (also known in the art as top jaws) are constructed to be securely bolted on top of the respective hard jaws 12, 14, 16 (also know as master jaws) by means of conventional bolts (not shown). In accordance with conventional design, shoulder bolts are received in counterbored holes (not shown) in the soft jaws and extend therefrom to threadedly engage the respective hard jaws. Such structure is convention and found on most standard lathe chucks. By means of known locking means, the soft jaws are locked for the purpose of machining to fit the workpiece to be held by full chuck pressure.

One such jaw setting means is shown in U. S. Pat. No. 2,777,704 and comprises a jaw actuating plunger supported for reciprocation axially of the chuck and located within the central bore formed in the chuck body. The plunger affects simultaneous gripping action by the jaws upon the workpiece through suitable means, such as bell cranks or operating levers which are mounted on suitable pivot shafts, and connect the plunger to the master or hard jaws, respectively. The hard jaws are retained in radial guide ways by conventional, rabbeted construction, as is well known in the art. The plunger is caused to reciprocate by suitable means to affect simultaneous radial motion of the hard jaws relative to the central axis of the chuck. Many chucks are provided with hydraulic actuation means for providing holding pressures which can exceed 10,000 p.s.i. It is also well known to have chucks with more than the three jaws shown, although the three jaw version illustrated is, perhaps, the most common and widely used version. The present invention is not limited by the number of jaws in a chuck.

The subject invention is a master link which is formed by a heavy duty roller chain with end hooks and safety pins on each end of the chain. The master chain 24 comprises a length of roller chain 26 with end hooks 26, 28 fixed to the respective opposite ends of the chain. The end hooks may be substantially identical. However, they are fastened to the roller chain facing in opposite directions to the axis of the chain. It should be noted that the overall length of the chain may be different for different lathes and/or applications, largely depending upon the chuck diameter and the number of jaws in the chuck. However, a wide variety of chuck sizes can be accommodated with only one size length of chain.

The subject invention allows machinists to be able to machine the soft jaws accurately, concentrically, and with time efficiency. It also eliminates any backlash off any multiple jaw chuck. In most of the machining done with Engine Lathes or CNC Lathes, the parts to be machined have to be held with soft jaws to assure the best concentricity and squareness of the machined parts. The subject master link is designed to hold all jaws in position and take up all backlash, or play, while the part is being re-machined. The subject master link will adapt to any multiple jaw chuck, regardless of the number of jaws. When the soft jaws have to be re-machined from the outside, to hold parts by their inside diameters, the subject master chain can be adjusted to any size within the safety range of the chuck thereby eliminating all unnecessary tooling. Thus, the subject invention will save lots of time to any machinist and/or machining company.

The subject master chain is used in the following manner. First, the chuck jaws are adjusted to any desired diameter. The master link is formed into a loop around the circumference of the chuck or the soft jaws to be machined. The master link is removed from the chuck without losing the mark for the desired diameter. One end hook, preferably the outwardly directed hook, is then slipped through the chain link to engage in the respective adjacent roller of the link chain. Then the opposite end hook, the inwardly directed hook, is pulled to take up any chain slack and then it is likewise engaged in a respective adjacent roller of the link chain, making sure both end hooks are engaged on the roller chain. The hooks can be further secured by using locking pins (not shown) in the usual manner for such locking pins. Then the master link is placed back on the chuck at a desired location where it will not interfere with the machining of the soft jaws.

The second end hook acts as a safety catch and also keeps excess chain from whipping while chuck is turning.

Once the master link is looped and both hooks are in place, the chuck jaws are adjusted tight against the work piece, making sure all jaws are held tight by the master link

The present invention may be subject to many modifications and changes without departing from the spirit or essential characteristics thereof. The above described embodiment should therefor be considered in all respects as illustrative and not restrictive of the scope of the present invention as defined by the appended claims.

I claim:

1. In combination with a rotatable chuck having a head with at least three jaws mounted thereon for radial movement, master link means to hold said jaws in place comprising:
a length of heavy duty roller chain with end hooks on each end of the chain, said end hooks, when said chain is made into a circle, engaging rollers of said chain to define a circle of specific size so that when applied to the jaws of said chuck said master link restrains the outward movement of said jaws.

2. The combination according to claim 1 wherein said chuck has more than three jaws.

3. The combination according to claim 1 wherein a machinist is enabled to machine parts held in the chuck jaws in the outside direction.

4. The combination according to claim 1 wherein said master link adapts to any diameter chuck within a safety range and holds the chuck jaws in place accurately with maximum rigidity.

5. The combination according to claim 1 wherein said master link eliminates all backlash and allows for jaws to run concentric as well as perpendicular.

6. The combination according to claim 1 wherein said end hooks have locking means.

7. The combination according to claim 1 wherein said end hooks are oppositely directed with respect to the longitudinal axis of said chain.

8. Master link means for securing the jaws of a rotatable chuck having a head with at least three jaws mounted thereon for radial movement, master link means comprising:
a length of heavy duty roller chain with end hooks on each end of the chain, said end hooks, when said chain is made into a circle, engaging rollers of said chain to define a circle of specific size so that when applied to the jaws of said chuck said master link restrains the outward movement of said jaws.

9. The combination according to claim 8 wherein said end hooks have locking means.

10. The combination according to claim 8 wherein said end hooks are oppositely directed with respect to the longitudinal axis of said chain.
